(19) United States
(12) Patent Application Publication
(10) Pub. No.: US 2014/0123646 A1
(43) Pub. Date: May 8, 2014

(54) Concentrating Solar Power Methods and Systems with Liquid-Solid Phase Change Material for Heat Transfer

(71) Applicants: Russell Muren, Boulder, CO (US); Luke Erickson, Lakewood, CO (US)

(72) Inventors: Russell Muren, Boulder, CO (US); Luke Erickson, Lakewood, CO (US)

(73) Assignee: ABENGOA SOLAR LLC, Lakewood, CO (US)

(21) Appl. No.: 14/130,617

(22) PCT Filed: Jul. 3, 2012
(86) PCT No.: PCT/US12/45425

§ 371 Date: Jan. 2, 2014

Related U.S. Application Data
(60) Provisional application No. 61/504,698, filed on Jul. 5, 2011.

(51) Int. Cl. F24J 2/07; F03G 6/06; F24J 2/46; F24J 2/34; F24J 2/10

(52) U.S. Cl. CPC F24J 2/07; F24J 2/34; F24J 2/10; F24J 2/4649; F03G 6/06
USPC 60/641.11; 126/641; 126/678

(57) ABSTRACT

Concentrating solar power systems and methods featuring the use of a solid-liquid phase change heat transfer material (HTM). The systems and methods include a solar receiver to heat and melt a quantity of solid HTM. Systems also include a heat exchanger in fluid communication with the solar receiver providing for heat exchange between the liquid HTM and the working fluid of a power generation block. The systems and methods also include a hot storage tank in communication with the solar receiver and the heat exchanger. The hot storage tank is configured to receive a portion of the liquid HTM from the solar receiver for direct storage as a thermal energy storage medium. Thus, the system features the use of a phase change HTM functioning as both a heat transfer medium and a thermal energy storage medium.

### TECHNICAL FIELD

The embodiments disclosed herein relate generally to concentrating solar power (“CSP”) technology and more particular to CSP technologies that utilize a heat transfer material (“HTM”) undergoing solid to liquid and liquid to solid phase change during a heat transfer cycle.

### BACKGROUND

Concentrating Solar Power (CSP) systems utilize solar energy to drive a thermal power cycle for the generation of electricity. CSP technologies include parabolic trough, linear Fresnel, central receiver or “power tower,” and dish/engine systems. Considerable interest in CSP has been driven by renewable energy portfolio standards applicable to energy providers in the southwestern United States and renewable energy feed-in tariffs in Spain. CSP systems are typically deployed as large, centralized power plants to take advantage of economies of scale. A key advantage of certain CSP systems, in particular parabolic troughs and power towers, is the ability to incorporate thermal energy storage. Thermal energy storage (TES) is often less expensive and more efficient than electric energy storage such as batteries for example. In addition, TES allows CSP plants to have an increased capacity factor and dispatch power as needed, to cover evening or other demand peaks for example.

CSP plants often utilize oil, molten salt or steam to transfer solar energy from a solar energy collection field, solar receiver tower or other apparatus to a power generation block. These materials typically flow in a system of pipes or ducts as a gas or liquid and are thus generally referred to as “heat transfer fluids”(HTF). Typical HTFs are flowed through heat exchange apparatus to heat water to steam or to heat an alternative “working fluid” to an operational temperature which is then used on a power generation cycle to drive a turbine and generate electric power. Commonly utilized HTFs have properties that in certain instances limit overall CSP plant performance. For example, one commonly used synthetic oil HTF has an upper temperature limit of 390° C., molten salt has an upper temperature limit of about 565° C. while direct steam generation requires complex controls and allows for limited thermal storage capacity.

CSP plants that employ a HTF undergoing a liquid-gas phase transition are known in the art. For example, U.S. Pat. No. 8,181,641 and U.S. Pat. No. 4,117,682 each propose a tower arrangement and a HTF exhibiting a liquid-gas phase change. Such technology benefits from the high thermal capacity of a material undergoing a liquid-gas phase transition and the large heat transfer coefficients associated with two-phase flow in the receiver. In a liquid-gas phase transition system, the heated HTF is necessarily in a gas phase; therefore, efficient thermal energy storage can be difficult. Additionally, the power cycle efficiency is somewhat limited by temperature to somewhat less efficient cycles such as a superheated Rankine power cycle.

Alternatively, a system and receiver design may feature a solid heat transfer material (HTM). One known system features falling solid particles that are illuminated and heated by concentrated solar flux, as described by Evans et al. in 1985 “Numerical Modeling of a Solid Particle Solar Central Receiver” Sandia Report SAND85-8249. A solid particle CSP design can produce higher theoretical maximum temperatures, and therefore can take advantage of higher theoretical power cycle efficiencies. Unfortunately, convective losses for a solid particle receiver system are high, in large part due to the interaction of the falling particles and the air within the receiver. If a window is used to limit air-particle interactions, other design challenges arise which can affect overall system efficiency, window absorption for example. In addition, the use of windows in a solar receiver increases the difficulty of maintaining acceptable window transparency and avoiding breakage.

CSP plants using a liquid salt HTF are also known in the art. For example, U.S. Pat. Nos. 6,701,711 and 4,384,550 disclose tower-based molten salt receiver system, and U.S. Pat. No. 7,051,529 discloses a dish-based system. These systems depend upon the HTF remaining in a liquid state as it passes through receiver, storage, and heat exchanger elements of the system. The use of a liquid HTF allows for simple thermal energy storage by way of a thermally isolated tank, but creates the problem of maintaining HTF having an inherently high freezing point in liquid form. Furthermore, the efficiency of solar heat transfer inside a liquid HTF receiver is reduced by the need to maintain HTF in only the liquid phase.

A parabolic solar trough having a solid-liquid phase-change material (“PCM”) confined within the receiver is described in U.S. Pat. No. 4,469,088. This solid-liquid PCM design allows for simultaneous heating of a separate, stationary thermal energy storage material and the HTF. However, because heat exchange between the thermal energy storage material and HTF must take place in this design in the receiver, overall system efficiency is limited due to prohibitive overall heat losses during charging, discharging, and standby.

CSP tower and trough systems that employ materials having a solid-liquid phase change are also described in U.S. Pat. No. 4,127,161 and W. Steinmann, and R. Tamme, “Latent heat storage for solar steam systems” Journal of Solar Energy 130(1) Engineering (2008). In these systems however, the thermal storage system is physically remote from the receiver, leading to inherently transient system performance and complicated operating strategies, as well as thermal degradation through the use of indirect heat exchangers.

The embodiments disclosed herein are directed toward overcoming one or more technical limitations including but not limited to the problems discussed above.

### SUMMARY OF THE EMBODIMENTS

Certain embodiments disclosed herein comprise concentrating solar power (CSP) systems. The CSP systems feature the use of a solid-liquid phase change heat transfer material (HTM). The systems include a solar receiver configured to receive concentrated solar flux to heat a quantity of the solid HTM and cause a portion of the solid HTM to melt to a liquid HTM. The systems also include a heat exchanger in fluid communication with the solar receiver. The heat exchanger is configured to receive liquid HTM and provide for heat exchange between the liquid HTM and the working fluid of a power generation block. The heat exchanger further provides for the solidification of the liquid HTM. The systems also include a material transport system providing for transportation of the solidified HTM from the heat exchanger to the solar receiver.

In addition, the system embodiments include a hot storage tank in fluid communication with the solar receiver and the heat exchanger. The hot storage tank is configured to receive a portion of the liquid HTM from the solar receiver for direct storage as a thermal energy storage medium. Thus, the systems feature the use of a phase change HTM functioning as both a heat transfer medium and a thermal energy storage medium. Therefore, a separate thermal energy storage system and heat exchangers between the HTM and the separate thermal energy storage medium can be avoided.

In some embodiments, the system may further include a cold storage tank in mechanical or fluid communication with the solidification stage and the solar receiver. The cold storage tank provides for storage of solid HTM downstream from the heat exchanger.

The heat exchanger element may be implemented with separate pathways for the HTM and the working fluid such that no physical contact between the two fluid streams occurs. Alternatively, the heat exchanger may be implemented with a direct contact apparatus which facilitates heat exchange by direct physical contact between the HTM and working fluid. The heat exchanger element may be implemented with one or multiple heat exchanging stages. In certain embodiments a direct contact heat exchanger may comprise a priller. In other embodiments a multiple-stage heat exchanger may include at least a primary stage and a solidification stage. The solidification stage could be implemented as a billet extruding or casting device.

System embodiments may be implemented with any suitable material as the HTM, provided the HTM exhibits a solid-liquid phase change at a suitable temperature. For example, the system may be implemented with an aluminum alloy as the HTM. System embodiments may also be implemented with any type of power block using any type of power cycle and any working fluid. For example, the system may be implemented with supercritical CO₂ (s-CO₂) water or other materials as the working fluid.

In certain embodiments, the solar receiver element may comprise multiple receiver tubes oriented substantially vertically. The material transport system provides for transportation of solid HTM or a mixture of solid and liquid HTM to an opening in one or more of the multiple receiver tubes. In addition, one or more exits from the receiver tubes provide for the flow of heated liquid HTM from the receiver.

System embodiments may include a solar receiver having one or more receiver tubes containing HTM in a phase which is different from the phase of the HTM in other receiver tubes. For example the system may include one or more receiver tubes having a flow of substantially solid-phase HTM, one or more receiver tubes containing a flow of mixed solid and liquid HTM and one or more receiver tubes containing a flow of substantially liquid phase HTM. The system may also include a tower supporting the solar receiver. A tower-based system may include solid and liquid receiver hoppers located within the tower and configured to provide for the loading of HTM into the receiver.

Alternative embodiments include solar receivers configured as described above.

Other alternative embodiments are methods of generating power. The method embodiments include the steps of providing a solid-liquid phase change HTM, placing solid HTM into a solar receiver configured to receive concentrated solar flux and heating the solid HTM in the receiver to cause the solid HTM to melt to a liquid phase. The methods further include storing at least a portion of the liquid HTM in a hot thermal energy storage tank.

The methods also include exchanging heat between the liquid HTM and the working fluid of a power generation block. Heat exchange causes the working fluid to be heated to an operational temperature and also causes solidification of the liquid HTM. The liquid HTM used for heat exchange may be supplied directly from the solar receiver or from the hot thermal energy storage tank or both. The methods further include driving a power generation cycle with the energy of the heated working fluid. Solid HTM is transferred from the heat exchanger to the solar receiver for reheating.

The methods may further include storing solid HTM after heat exchange in a cold storage tank. As noted above, the heat exchange and solidification steps may be accomplished in single or multiple-stage heat exchangers. The heat exchanger element can be implemented with a direct contact heat exchanger or a heat exchanger where the HTM and working fluid are maintained in separate flows.

### BRIEF DESCRIPTION OF THE DRAWINGS

FIG. 1 is a schematic diagram of a Concentrating Solar Power (CSP) system.

FIG. 2 is a schematic diagram of an alternative CSP system.

FIG. 3 is a schematic diagram of an alternative CSP system featuring prilled solid-phase heat transfer material (HTM).

FIG. 4 is a schematic diagram of an alternative CSP system featuring rectangular billet solid-phase heat transfer material (HTM).

FIG. 5 is a schematic diagram of an alternative CSP system featuring round cross section billet or rod type solid-phase heat transfer material (HTM).

FIG. 6 is a schematic diagram of the solidification stage of the CSP system of FIG. 4.

FIG. 7 is a graph representation of the modeled temperature profiles of a selected HTM and working fluid in a single stage, direct contact heat exchanger.

FIG. 8 is a graph representation of the modeled temperature profiles of the selected HTM and working fluid in a two stage heat exchanger having a solidification stage.

FIG. 9 is a schematic diagram of a solar receiver configuration showing a flow pattern for solid, mixed solid and liquid and liquid HTM.

FIG. 10 is a schematic diagram of an alternative solar receiver configuration showing a flow pattern for solid, mixed solid and liquid and liquid HTM.

FIG. 11 is a schematic diagram of an alternative solar receiver configuration showing a flow pattern for solid, mixed solid and liquid and liquid HTM.

FIG. 12 is a schematic diagram of an alternative solar receiver configuration showing a flow pattern for solid, mixed solid and liquid and liquid HTM.

FIG. 13 is a schematic diagram of an alternative solar receiver configuration showing a flow pattern for solid, mixed solid and liquid and liquid HTM.

FIG. 14 is a schematic diagram of an alternative solar receiver configuration showing a flow pattern for solid, mixed solid and liquid and liquid HTM.

FIG. 15 is a plan view schematic diagram of a solar cavity receiver featuring separate receiver tubes for flows of solid, mixed solid and liquid and liquid HTM wherein the tubes are arranged to enhance efficiency.

FIG. 16 is a plan view schematic diagram of a solar cavity receiver featuring separate receiver tubes for flows of solid, mixed solid and liquid and liquid HTM wherein the tubes are arranged to enhance efficiency.

FIG. 17 is a plan view schematic diagram of a solar cavity receiver featuring separate receiver tubes for flows of solid, mixed solid and liquid and liquid HTM wherein the tubes are arranged to enhance efficiency.

FIG. 18 is a plan view schematic diagram of a circular receiver featuring separate receiver tubes for flows of solid, mixed solid and liquid and liquid HTM wherein the tubes are arranged to enhance efficiency.

FIG. 19 is a plan view schematic diagram of a circular receiver featuring separate receiver tubes for flows of solid, mixed solid and liquid and liquid HTM wherein the tubes are arranged to enhance efficiency.

FIG. 20 is an isometric diagram of a solar receiver configured to receive billets of solid HTM.

FIG. 21 is an isometric diagram of a circular solar receiver configured to receive billets of solid HTM.

FIG. 22 is an isometric diagram of a circular solar receiver configured to receive ground, shredded or prilled solid HTM.

FIG. 23 is a graph representation of the projected system efficiency of the disclosed system embodiments operated at selected temperatures.

### DETAILED DESCRIPTION

Unless otherwise indicated, all numbers expressing quantities of ingredients, dimensions reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

The embodiments disclosed herein include CSP systems featuring the use of solid-liquid phase change material as a heat transfer material (HTM). The term “heat transfer material” is used herein instead of the more commonly seen “heat transfer fluid” because in certain embodiments the HTM of the disclosed embodiments is moved, stored and utilized as a non-fluid solid.

As defined herein a solid-liquid phase change material is a material which exists in a solid phase at cooler operating temperatures but melts to a liquid phase at hotter operating temperatures. The various embodiments disclosed herein include CSP systems where the HTM and thermal energy storage (TES) material are the same material. Thus, heat exchange between the HTM and a separate TES system utilizing a separate TES material can be avoided. One benefit of utilizing a phase change material as the HTM and TES of a CSP system is the high energy density realized by exploiting the latent heat as well as the sensible heat of a suitable HTM/TES material. The energy storage density of a suitable HTM material can typically be doubled by exploiting the latent heat storage of a phase change transition.

Phase change materials suitable for use as an HTM include salts, organic and inorganic polymers, and metals. In particular, the HTM could be comprised of a nitrate, carbonate, bromide, chloride, fluoride, hydroxide, or sulfate salt, zinc, boron, beryllium, lead, magnesium, copper, aluminum, tin, antimony, manganese, iron, nickel or silicon, an alloy of any metals, a plastic, a wax organic material or a miscible or immiscible mixture of any of the above that is capable of storing heat in a sensible and latent form. The specific choice of an HTM is determined by specific application requirements. For example, in systems operating at high temperatures, typically above around 600 C, aluminum alloys may be used as the HTM, while in systems operating at medium temperatures, typically around 400 C, nitrate salts may be the most suitable HTM. At still lower temperatures, typically below 200 C, hydrate salts and organic waxes may be the most suitable HTM.

The HTM utilized in the various embodiments disclosed herein may, when in a solid phase, be processed to have one or more of many alternative forms, shapes, or structures. In the disclosed embodiments the HTM is delivered to a solar receiver or other solar energy concentrating apparatus in at least a partially solid phase. For example, the HTM may be delivered to a solar receiver as a prill or prilled material. As used herein a “prill” is a granular and relatively free-flowing material. In alternative embodiments the HTM may be processed and delivered to the receiver as an extruded or cast solid billet, a cylindrical solid billet or rod, a shredded solid, a particulate or granular solid or other suitable form. In certain embodiments the solid HTM may be mixed with liquid HTM and delivered to the solar receiver as slurry.

Several specific receiver designs are described below. In each embodiment, the solar receiver is configured to heat the HTM and cause at least some solid HTM to melt. The disclosed systems also include one or more heat exchangers in fluid and thermal communication with the solar receiver and receiving liquid HTM directly or indirectly from the receiver. The heat exchanger(s) may be of any type or any level of sophistication needed to provide for heat exchange between the liquid HTM and a power generation cycle working fluid. The heat exchanger(s) also provide for the cooling and solidification of liquid HTM in conjunction with heating the working fluid.

The heat exchanger elements and other subsystems are, for technical convenience described and shown in the figures as simple schematic elements. All elements of a commercial system would be implemented with more complex apparatus.

The disclosed systems also include a material transport system providing for the transportation of solid HTM from the outlet of the heat exchanger to the solar receiver for reheating. Thus, some or all of the HTM undergoes a thermal cycle including a solid to liquid phase change as solar energy is applied to the HTM and a liquid to solid phase change as energy is exchanged with a working fluid.

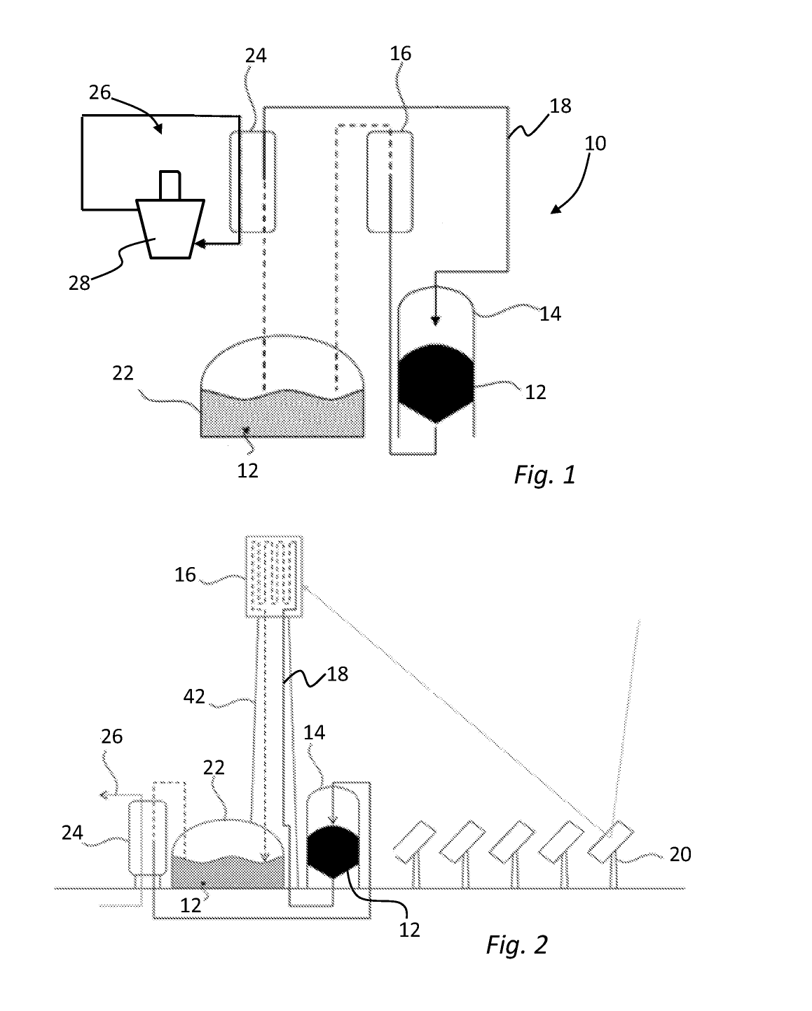

One CSP system 10 is schematically illustrated in FIGS. 1-2. The system 10 features the use of a solid-liquid phase change HTM 12 stored at the coolest portion of a thermal cycle in the form of prill in a cold storage tank or vessel 14. Although designated a “cold” storage tank 14, it is important to note that the term “cold” is relative. Typically the cold storage tank will house solid-phase HTM at a temperature only somewhat below the HTM melting point. Thus, the cold storage tank 14 must be insulated and fabricated from materials which are suitably durable at the desired temperatures.

The prilled HTM 12 is moved to the inlet of a solar receiver 16 with a material transport system 18. In the solar receiver 16, concentrated sunlight, for example, sunlight reflected from a field of heliostats 20, heats the HTM 12 causing a solid to liquid phase change in at least some of the HTM and possibly causing additional heating of the liquid HTM. Several specific receiver embodiments are described in detail below. Although the embodiments described herein and shown in the figures relate primarily to a tower-mounted receiver 16 illuminated by a field of heliostats 20, the systems and methods disclosed herein could be implemented in alternative CSP plant configurations. For example, the systems and methods disclosed herein could be implemented in parabolic trough, linear Fresnel, or dish/engine CSP systems as well.

Downstream from the solar receiver 16, liquid HTM 12 may be temporarily stored in a hot storage tank 22. The hot storage tank 22 is the primary TES of the system 10 and thus serves to balance system transient response and extend operations into periods such as the evening or night where solar flux is limited or unavailable. The hot storage tank must be fabricated from a material such as steel lined with alumina brick which provides insulation and which is stable at the highest operating temperatures expected of liquid HTM at the receiver outlet. Storage tanks designed for aluminum smelting operations may be repurposed as hot storage tanks 22 if an aluminum alloy is used as the HTM. Although not shown in the figures it should be appreciated that suitable ducts, pipes and valves will be included in a commercial implementation to allow a plant operator to direct hot HTM to and from the hot storage tank 22 to accomplish TES charging during periods of high solar flux or TES discharging as desired. Because heat transfer and thermal energy storage are achieved with the same PCM/HTM, there is no thermal degradation arising from placing a heat exchanger between separate heat transfer and thermal energy storage fluids.

Heated liquid HTM 12 is taken from the outlet of the solar receiver 16 or from the outlet of the hot storage tank 22, or both, and flowed through a heat exchanger apparatus 24. In the heat exchanger 24 which may include several sub-elements or stages, heat exchange occurs between the HTM and the working fluid of a power generation block 26. The embodiments disclosed herein are not limited to any specific type of heat exchanger 24, power generation block 26 or any specific working fluid. The high operating temperatures achievable with certain types of HTM facilitate use with higher temperature thermodynamic power production cycles for example a supercritical CO2 (s-CO2) Brayton cycle. All types of power block 26 will include one or more turbines 28 which are operated by the heated working fluid to generate electricity. The power block 26 will typically include some or all of the following power block elements: turbines 28, compressors, condensers, expansion stages, recuperators, heat exchangers and associated pipes, ducts, valves and controls.

The heat exchanger 24 may include separate HTM and working fluid conduits such that heat is exchanged between the HTM and working fluid without physical mixing of the HTM and working fluid streams. Alternatively, a direct contact heat exchanger may be utilized where liquid HTM interacts directly into the working fluid of the power cycle. In a direct contact heat exchanger, direct physical contact between the HTM and the working fluid heats the working fluid as the liquid HTM is solidified. Once formed, the solid HTM may be separated from the working fluid using a continuous slagging process. The solid HTM can then be moved to the cold storage vessel 14 and/or receiver 16 with the solid transport system 18.

The heat exchanger 24 thus provides two important functions with respect to the overall system 10. First, the heat exchanger 24 provides for heat energy to be transferred from the HTM to the working fluid to enable power generation. Concurrently, the heat exchanger provides for the working fluid to cool the HTM sufficiently to cause solidification of the HTM. The liquid to solid phase transition that occurs during heat transfer exploits the latent heat of the HTM to transfer more energy to the working fluid than would be possible in a system where phase change does not occur during the working fluid heat exchange process.

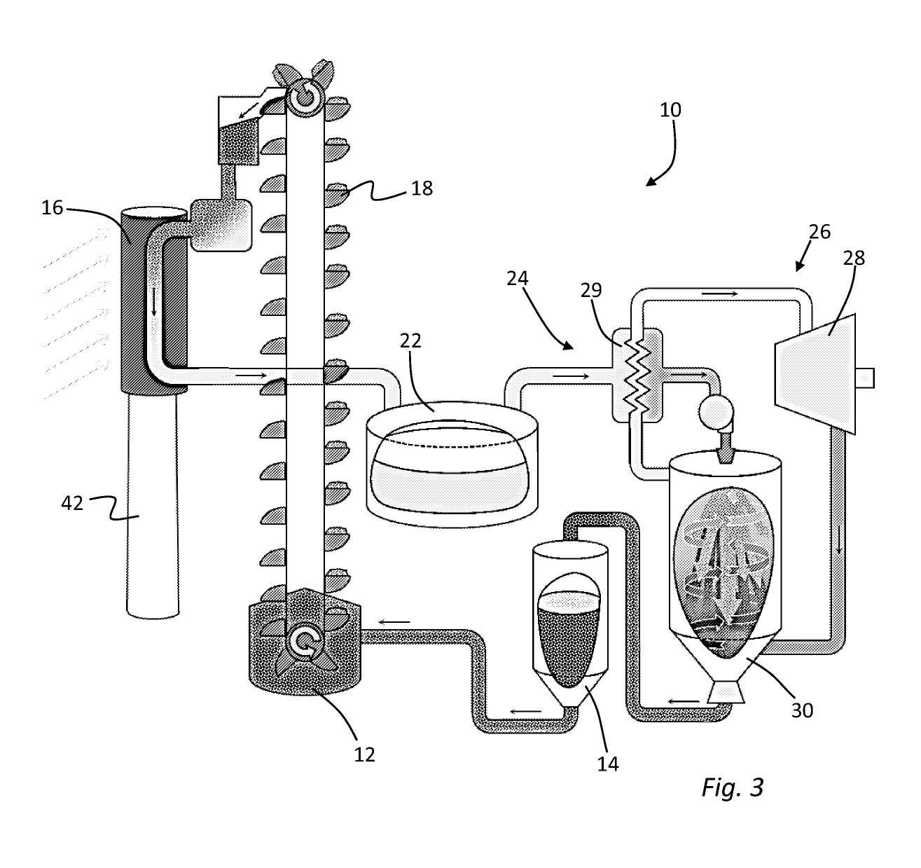

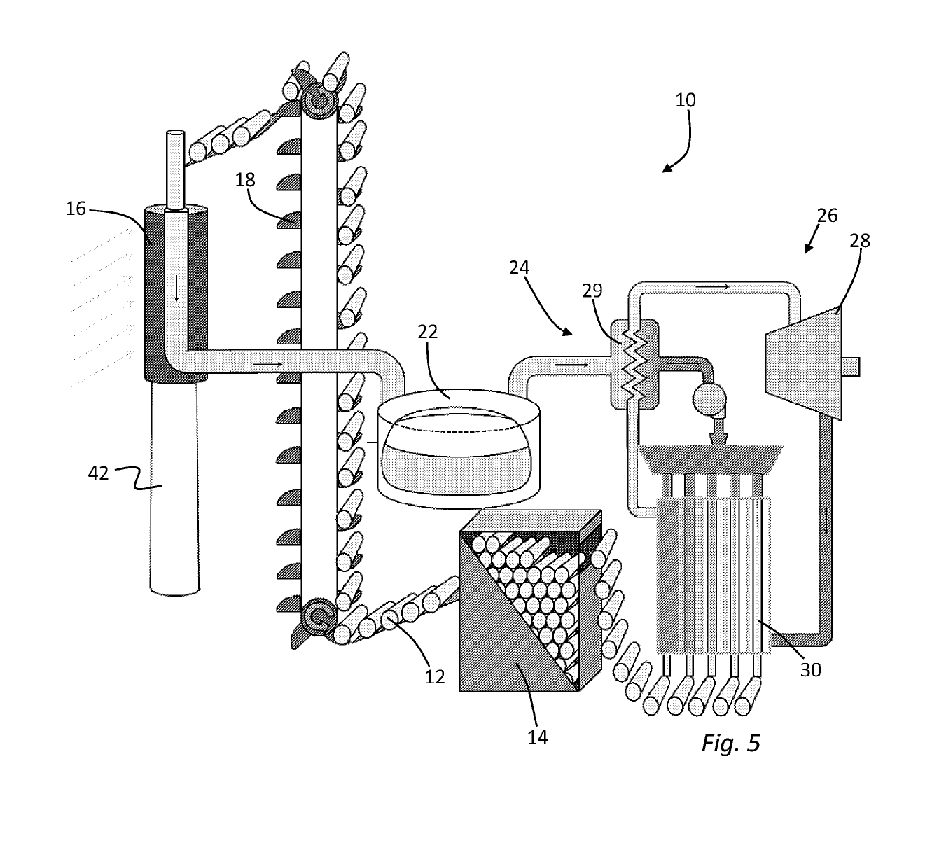

As noted above, the heat exchanger element may include multiple stages. For example, as shown in FIGS. 3-6, the heat exchanger may include a high-temperature stage 29 where sensible heat is exchanged between the HTM and working fluid while the HTM remains liquid. The heat exchanger 24 may further include a solidification stage 30 where heat exchange with the working fluid causes the HTM to solidify while pre-heating the working fluid. Thus, the solidification stage 30 is downstream from the high temperature stage 29 with respect to the HTM and upstream from the high temperature stage 29 with respect to the working fluid.

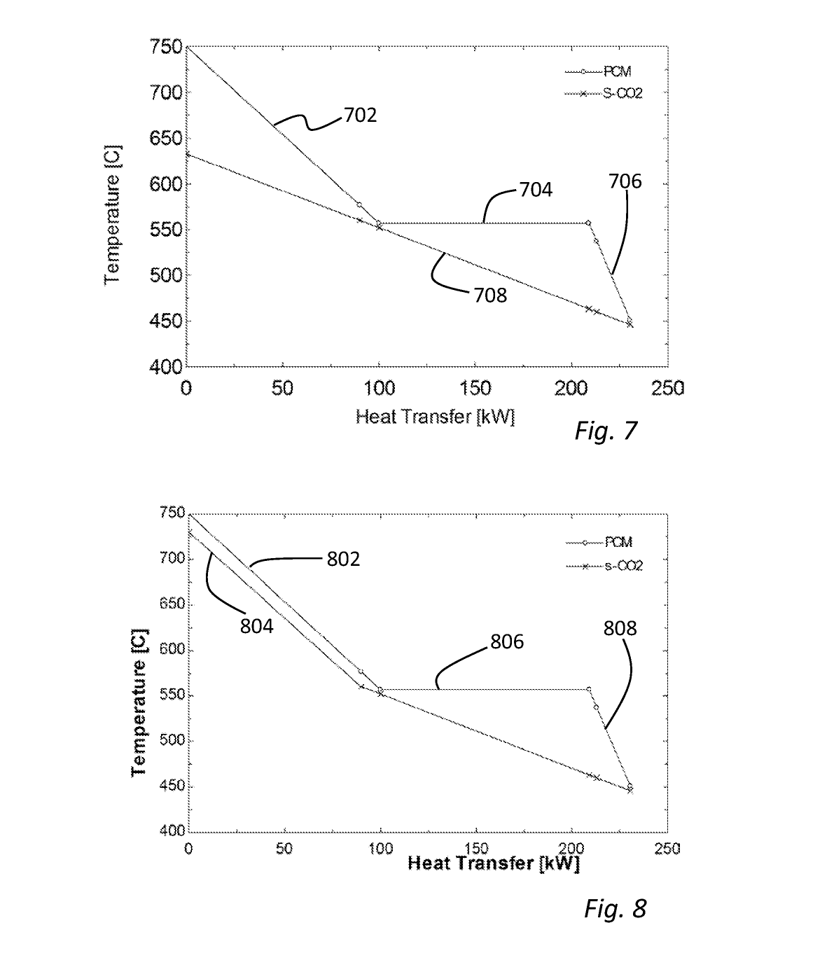

The nature of the heat exchanger 24, including any high temperature stage 29 or solidification stage 30 can be selected and implemented to control both system efficiency and the form desired for the HTM in a solid phase. For example, in one embodiment of CSP plant that processes solid HTM as prill (FIGS. 1-2) the heat exchanger 24 may be implemented as a single stage priller. In a single stage embodiment, liquid HTM, molten aluminum for example, is mixed directly with a working fluid, s-CO2 for example. As the two fluids interact, the HTM cools, and the working fluid gains heat. Initially (with respect to a given quantity of HTM), sensible heat is transferred from the liquid HTM to the cooler working fluid. This is illustrated in the graph of FIG. 7 as temperature profile segment 702. FIG. 7 shows the respective temperature profiles of a phase change material HTM and a working fluid as energy is transferred from the HTM to the working fluid. When the HTM cools to the freeze temperature, the HTM goes through an isothermal freeze process, shown as the flat temperature profile segment 704. The HTM then cools further as a solid (temperature profile segment 706). Since the working fluid does not change phase in this example, there is no isothermal section in the working fluid temperature profile 708.

The large gap between the initial HTM temperature and final working fluid temperatures illustrated on the left side of the FIG. 7 model is undesirable because the system would operate at higher efficiently if the working fluid temperature were closer to the initial, hottest HTM temperature. The heat exchanger element 24 may be configured to increase overall system efficiency by minimizing this temperature gap.

For example, the graph of FIG. 8 illustrates temperature profiles for the same materials modeled in FIG. 7, but with a two-stage heat exchanger configuration. On the left side of the FIG. 8 graph, temperature profile segments 802 and 804 illustrate the HTM and working fluid temperatures expected in a non-contact desuperheating heat exchanger, for example the high temperature stage 29 of FIGS. 3-6. In this stage, the working fluid flow rate may be set to make the temperature profiles of the respective materials parallel. The right side of the FIG. 8 graph illustrates the HTM temperature profile as a flat segment 806 throughout the solidification process with further reduction in temperature (temperature profile segment 808) as the solid cools is a solidification stage 30. Thus, a two or multiple stage heat exchanger configuration allows for optimization of the power cycle efficiency.

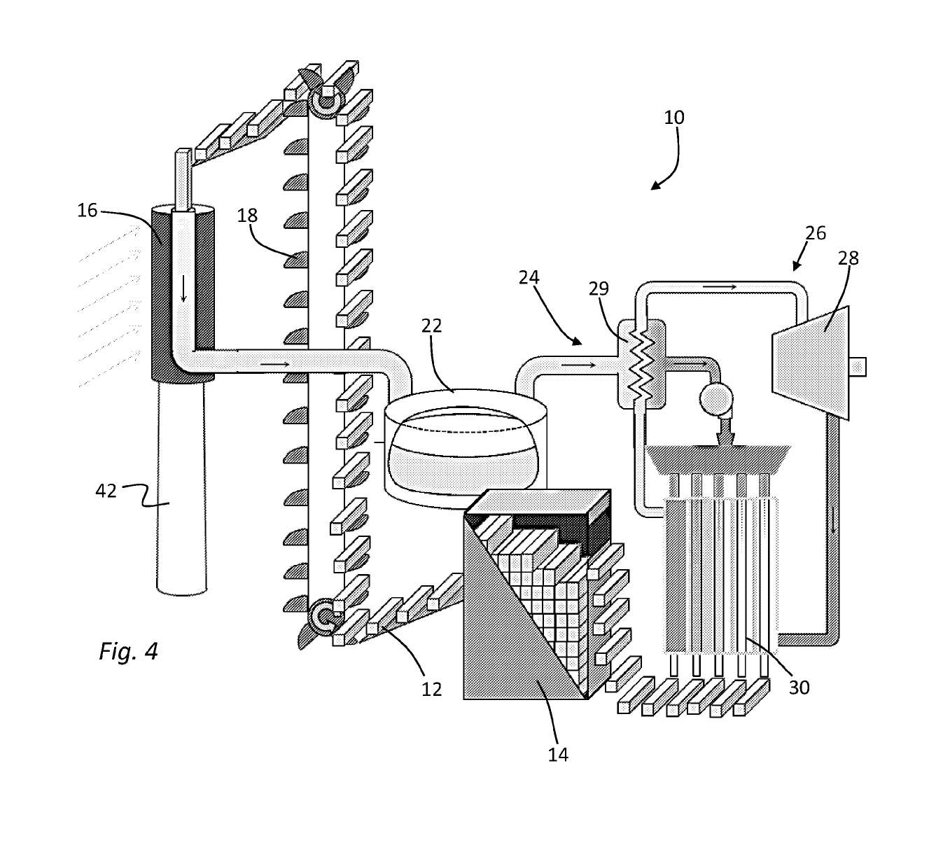

As noted above, the heat exchanger design may be selected to provide for solid HTM having a specific form or size. For example, as shown in FIGS. 4-6, the HTM may be fabricated, stored in cold storage 14 and delivered to the receiver 16 as an extruded or cast billet 32. A billet, rod, ingot or other larger solid form is particularly well-suited to implementations where the HTM is a metal or a metal alloy. For example, an aluminum alloy or an aluminum/silicon eutectic PCM alloy can be formulated to have a melting point suitable for use as the HTM in a high temperature CSP facility and can conveniently be formed into billets for automated transportation in the solid phase. The billets 32 can have a substantially rectangular, circular or other desired cross-section and can be of any size or length required for convenient handling.

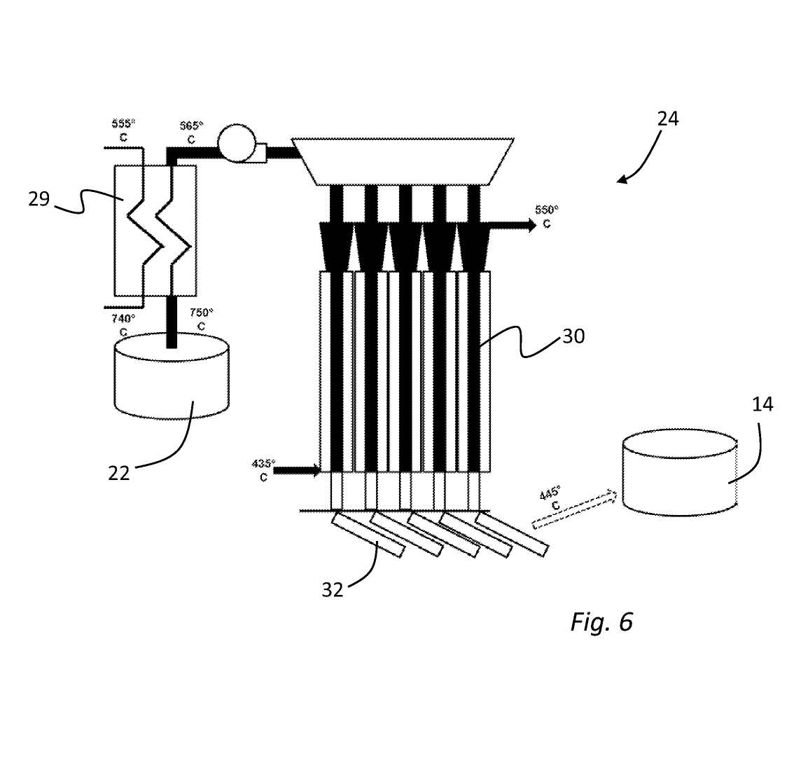

In systems 10 where the HTM is formed into a billet 32 or similar shape, the heat exchanger 24 will include a solidification stage 30 which may be implemented with any type of billet or rod casting or extruding mechanism. The solidification stage 30 is cooled by the working fluid, causing solidification and in addition pre-heating the working fluid. A representative billet casting solidification stage 30 is shown in FIG. 6 with the indicated temperatures being representative of the operational temperatures associated with an aluminum/silicon eutectic PCM/HTM and s-CO2 working fluid.

In all embodiments solidified HTM produced by the one, two or multiple-staged heat exchanger 24 may be returned by the solid transport system 18 to the receiver 16 or to the cold storage vessel 14, thereby establishing a continuous cycle. As shown in FIGS. 3-5, the solid transport system 18 may be implemented with a mechanical conveyor or other mechanical lifting system. Alternatively, the solid transport 18 may be implemented with an auger or screw lift, air lift or other known system or mechanism suitable for transporting solid substances.

The CSP systems 10 of FIGS. 3-5 are illustrated as having the HTM loaded into the receiver 16 substantially entirely in a solid phase. Alternatively, solid HTM may be pre-heated with solar energy or mixed with liquid HTM prior to loading into a receiver 16. In particular, the use of HTM in a prilled, granular, shredded or particulate form provides the opportunity to load the HTM into the receiver 16 as either a solid or slurry. In any embodiment, the HTM in whichever form it is provided initially may undergo a gradual phase change where solid portions of HTM flow with liquid portions for some period of time during heating.

In selected embodiments optimized for use with a prill, granular, shredded or other smaller-formed solid HTF, the system 10 may include a pump 34, a solid receiver hopper 36, a liquid receiver hopper 38, a mixer or mixing point 40, solid injection devices and other components located in or very near to the tower 42 and thus in close proximity to the receiver 16, as discussed in more detail below. The solid receiver hopper 36 could be the same or a separate container or vessel as the cold storage vessel 14. The mixing point 40 could be a dedicated mixing apparatus or a simple junction between two material flows where mixing can occur.

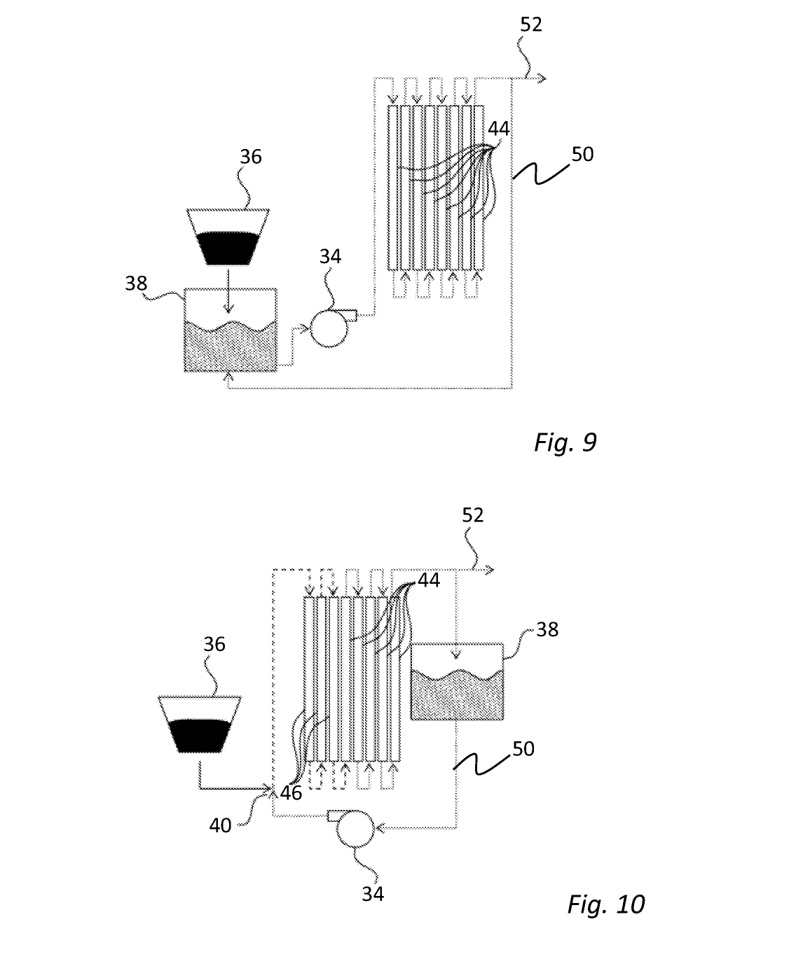

In the embodiments of FIGS. 9-19, solid prill or other relatively small-formed HTM is passed through one or more mixing points and receiver tubes while the receiver tubes are illuminated by concentrated solar flux. Depending upon the arrangement of receiver tubes, certain tubes may contain HTM in solid, liquid or slurry form. Various arrangements of solid/slurry/liquid filled receiver tubes are illustrated in FIGS. 9-19 and described below. The particular embodiment employed in any system implementation will depend on the solar resource available and the size of the associated power block.

In FIGS. 9-19, tubes having liquid-phase flow are marked as receiver tubes 44. Tubes holding flows of solid-liquid slurry of various volumetric proportions are indicated as receiver tubes 46. Tubes containing substantially solid-phase HTM flows moved by gravity, mechanical conveyance, or by forced gas entrapment are marked as receiver tubes 48.

FIG. 9 shows a receiver flow configuration where solid HTM from the solidification stage 30 or cold storage tank 14 is fed from a solid hopper 36 into a liquid receiver hopper 38. The solid HTM melts in the liquid hopper before being pumped through the liquid receiver tubes 44. Upon exiting the receiver 16, the liquid HTM flow is split into a bypass line 50 that leads to the liquid receiver hopper 38 and a main line 52 that leads to the hot storage tank 22 or heat exchanger 24 (not shown in FIG. 9).

FIG. 10 illustrates a receiver flow configuration in which solid HTM from the solid receiver hopper 36 is mixed with a liquid HTM flow from the liquid receiver hopper 38 at a mixing point 40 to form slurry, which is introduced into the receiver 16. The slurry flows through the receiver tubes 46 where it is melted by solar flux and subsequently flows through the liquid receiver tubes 44. The HTM liquid then exits the receiver 16 where the flow is split into a bypass line 50 that leads to the liquid receiver hopper 38 and a main line 52 that leads to the hot storage tank 22 or heat exchanger 24 (not shown in FIG. 10). Slurry flows tend to increase heat transfer inside the receiver, allowing for reduced receiver size and surface temperature, and a reduction in radiation losses.

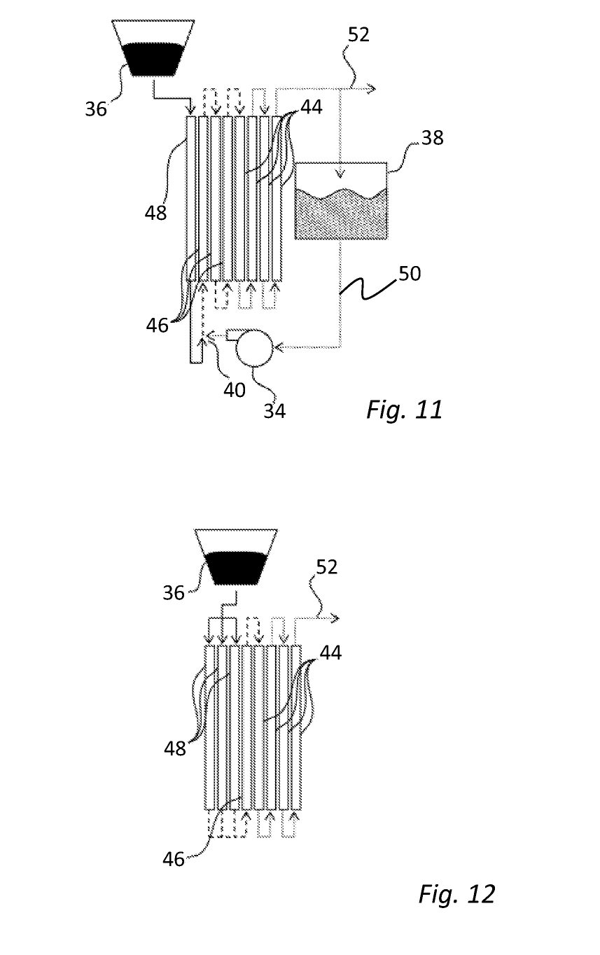

FIG. 11 illustrates another embodiment having a receiver flow configuration in which solid HTM flows or is moved from the solid receiver hopper 36 directly into solid receiver tubes 48. Once the solid HTM has been preheated by solar flux, liquid HTM is injected by pump 34 and slurry is formed at a mixing point 40. This slurry flows through the slurry receiver tubes 46 and subsequently through the liquid receiver tubes 44 after additional solar heating. The liquid HTM then exits the receiver 16 where the flow is split into a bypass line 50 and the main return line 52 as described above.

FIG. 12 shows another embodiment having a receiver flow configuration in which solid flows from the solid receiver hopper 36 directly into the solid receiver tubes 48 until a slurry is formed, at which point the HTM flows through the slurry receiver tubes 46 and subsequently the liquid receiver tubes 44 as the HTM is heated. After exiting the receiver 16, the HTM moves directly to the main line 52 for downstream storage or heat transfer.

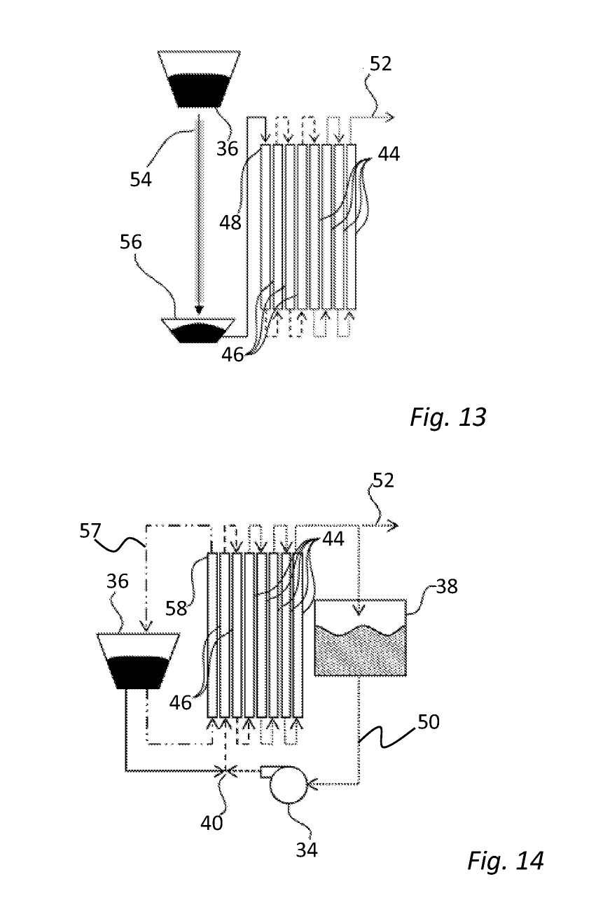

FIG. 13 shows an alternative receiver flow configuration in which the solid HTM flows or is moved from the solid receiver hopper 36 and is allowed to fall in front of the receiver tubes in a semi-transparent falling shroud 54. The solid HTF is thus pre-heated as it falls into a second solid receiver hopper 56, and is then caused to move in sequence through the solid receiver tubes 48, slurry receiver tubes 46 and the liquid receiver tubes 44 substantially as described above. Upon exiting the receiver 16, the fully heated liquid HTM flows directly to the main line 52 for downstream storage or heat transfer.

FIG. 14 shows a receiver flow configuration in which the solid HTM in the solid receiver hopper 36 thermally interacts with an immiscible secondary fluid 57. This secondary fluid flows through the secondary fluid receiver tubes 58 and is heated to a temperature below the melt point of the HTM. The heated secondary fluid flows back to the solid storage hopper 36 where it interacts with the solid prill through direct contact. The pre-heated solid prill is then mixed with hot liquid HTM at a mixing point 40 and flows as a slurry through the slurry receiver tubes 46 and subsequently the liquid receiver tubes 44. Fully heated HTM exits the receiver 16 and flows as described above.

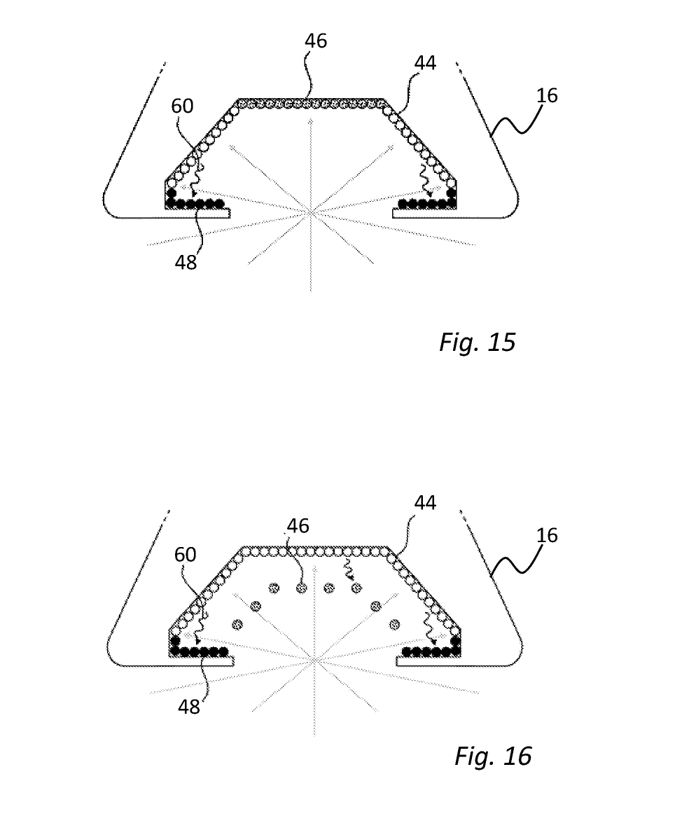

As noted above, system performance may be affected and in part controlled by the managed flow of HTM in various phases through receiver tubes. In addition, as shown in FIGS. 15-22 system performance and efficiency can be enhanced by optimizing the physical configuration of a solar receiver. The optimal receiver configuration will depend on the final size and solar resource of any given power plant.

As shown in FIG. 15, a cavity receiver 16 may be implemented with receiver tubes 48 carrying solid-phase HTM located against the inside of the outer cavity wall such that tubes 48 are not illuminated by concentrated flux, but are heated by re-radiated energy 60 from the other tubes. The slurry-filled receiver tubes 46 are placed in the area of highest concentration solar flux and the liquid-filled tubes 44 are placed in regions of lower flux concentration. In this manner, solar energy is used primarily to accomplish a phase change in the slurry HTM which is at the melting or freezing temperature, which enhances overall system efficiency.

FIG. 16 shows a cavity receiver 16 where the solid flow receiver tubes 48 are arrayed along the outer cavity wall such that they are not illuminated by concentrated solar flux but are only illuminated by re-radiated energy 60 from other receiver tubes. The slurry-filled tubes 46 are positioned within the cavity volume such that they are subjected to highly concentrated flux and partially shade the liquid-filled receiver tubes 44 which are arranged along the back wall of the cavity.

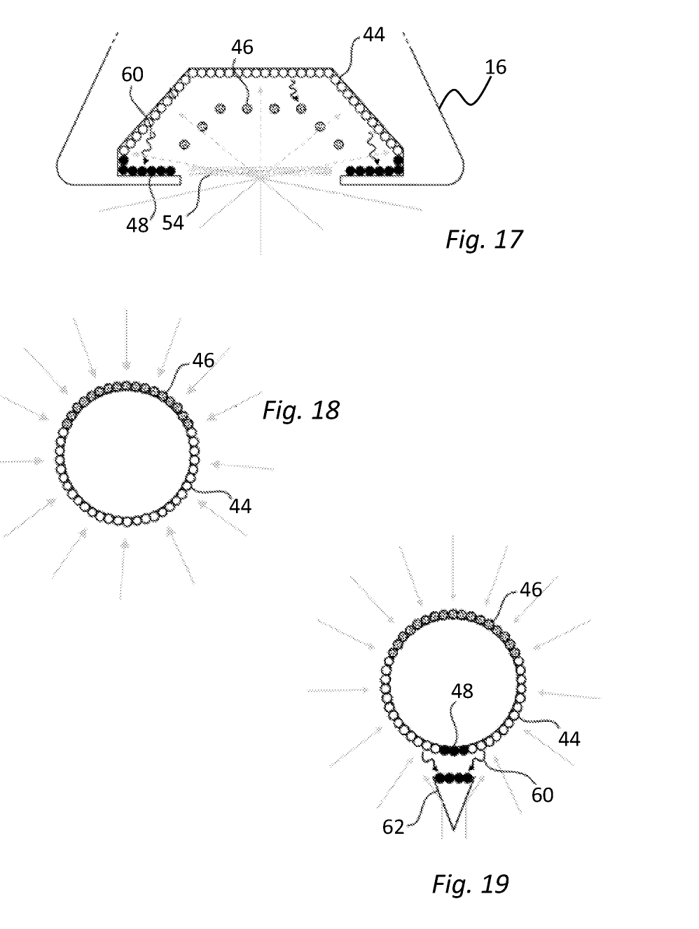

FIG. 17 shows a cavity receiver 16 where the solid-flow receiver tubes 48 are arrayed along the outer cavity wall such that they are not illuminated by concentrated solar flux but are only illuminated by re-radiated energy 60 from other receiver tubes. A falling semi-transparent shroud of solid particles 54 falls across the entrance of the cavity at a position of high flux. The slurry-filled tubes 46 are located inside the cavity volume such that they are subjected to highly concentrated flux and partially shade the liquid flow receiver tubes 44 which are arranged along the back wall of the cavity.

FIG. 18 shows an external receiver 16 in which the slurry-filled receiver tubes 46 are arranged on a portion of the receiver 16 with higher flux concentration and the liquid HTM filled tubes 44 are arranged on a portion of the receiver with a lower flux concentration.

FIG. 19 shows an external receiver 16 in which the solid HTM filled receiver tubes 48 are arranged on a portion of the receiver 16 that is shared by a reflective surface 62. The receiver tubes 48 are thus illuminated only with re-radiated and reflected energy 60. The slurry-filled tubes 46 are arranged in an area where the solar flux has the highest concentration. Liquid-filled receiver tubes 44 are arranged in an area where the solar flux is less concentrated.

As noted above, each of the receiver layouts illustrated in FIGS. 15-19, are configured to position the receiver tubes or HTM shrouds to minimize heat losses by capturing and utilizing re-radiated and reflected energy and by presenting the surfaces at the freezing/melting point of the HTM to the highest solar flux.

In general, the efficiency with which a receiver converts solar radiation to heat is determined by its operating temperature, various heat transfer coefficients and area under illumination. By utilizing a PCM as the HTM, fluids with superior thermal properties, like metals, and beneficial flow regimes can be introduced into the receiver. In addition, materials with higher thermal conductivities and densities will tend to increase the fatigue tolerance of the receiver and make the critical flux the receiver can absorb higher, shrinking overall receiver size. Further, as noted above, slurry flows tend to increase heat transfer inside the receiver, allowing for reduced receiver size and surface temperature, and a reduction in the radiation losses normally associated with higher receiver operating temperatures. Finally, because heat transfer and storage is accomplished with the same HTM, there is no thermal degradation arising from placing a heat exchanger between separate heat transfer and thermal energy storage fluids.

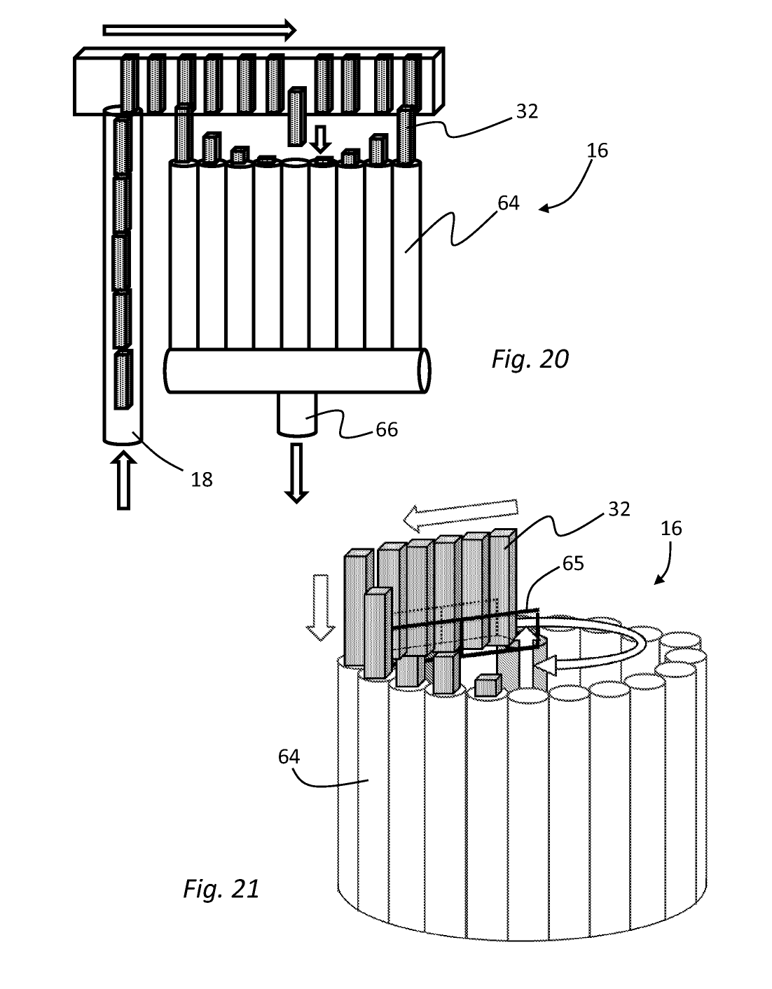

As noted above, certain embodiments utilize solid-phase HTM which has been cast, extruded or otherwise formed into a relatively large form solid after heat exchange and prior to storage or reinsertion into the solar receiver 16. As illustrated in FIGS. 20-22, the physical layout of the receiver can be optimized to process HTM delivered to the receiver as a billet, rod or other large solid.

In particular, FIG. 20 illustrates a parallel array of receiver tubes 64, which, for example could be arrayed at the region of highest solar flux in a cavity type receiver 16. The receiver 16 is associated with a material transport system 18 configured to load billets 32 vertically into each receiver tube 64. Billets 32 may be loaded sequentially or as needed. Solar flux concentrated on the receiver tubes 64 heats the solid billet HTM, causing a phase change transition from solid to liquid. Liquid HTM then flows out of the receiver 16 through an exit tube 66 for downstream storage, heat transfer and energy generation. The vertical arrangement of the receiver tubes 64 provides for convenient gravity feed of billets into the top of the receiver while liquid HTM flows out from the bottom.

FIG. 21 illustrates an alternative receiver 16 which also is configured to receive solid HTM billets 32 at the top. The receiver of FIG. 19 includes a circular array of receiver tubes 64. A distribution arm 65 rotates around the receiver to load billets into the receiver tubes. Inside the loaded tubes 64, the solid HTM is heated, melted and subsequently flows from the bottom of the receiver for downstream thermal energy storage, heat transfer and power generation purposes.

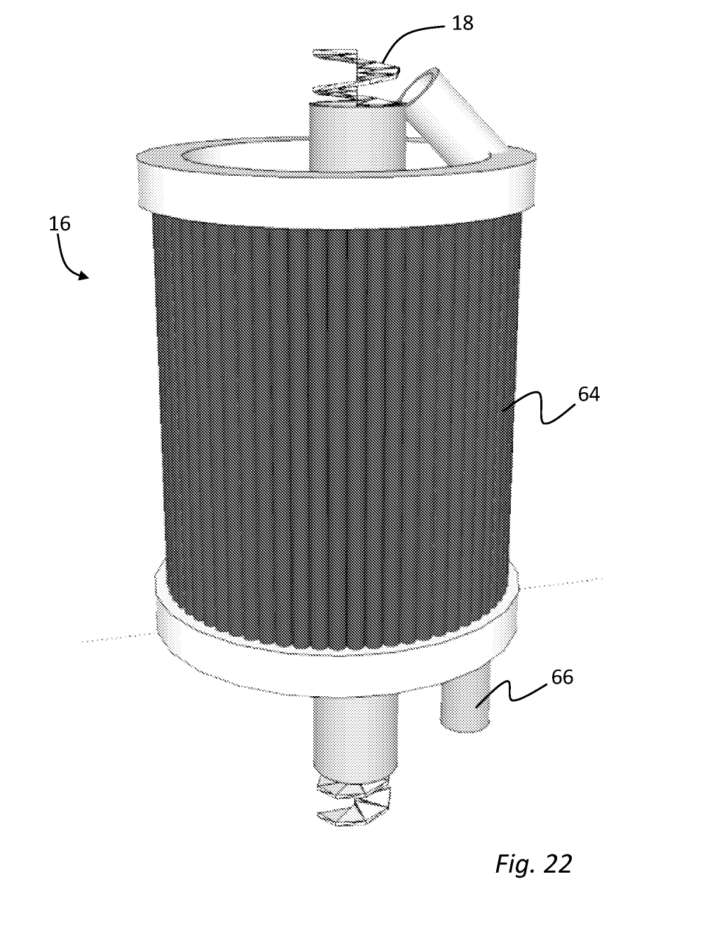

FIG. 22 illustrates an alternative receiver 16 which is specifically configured to receive granular, shredded or prill HTM lifted through the receiver body with a material transport system 18 configured as an auger screw lift and distributed to the receiver tubes 64. The HTM is melted within the receiver tubes 64 and flows out of the receiver 16 through an exit 66 for downstream thermal energy storage, heat transfer and power generation purposes.

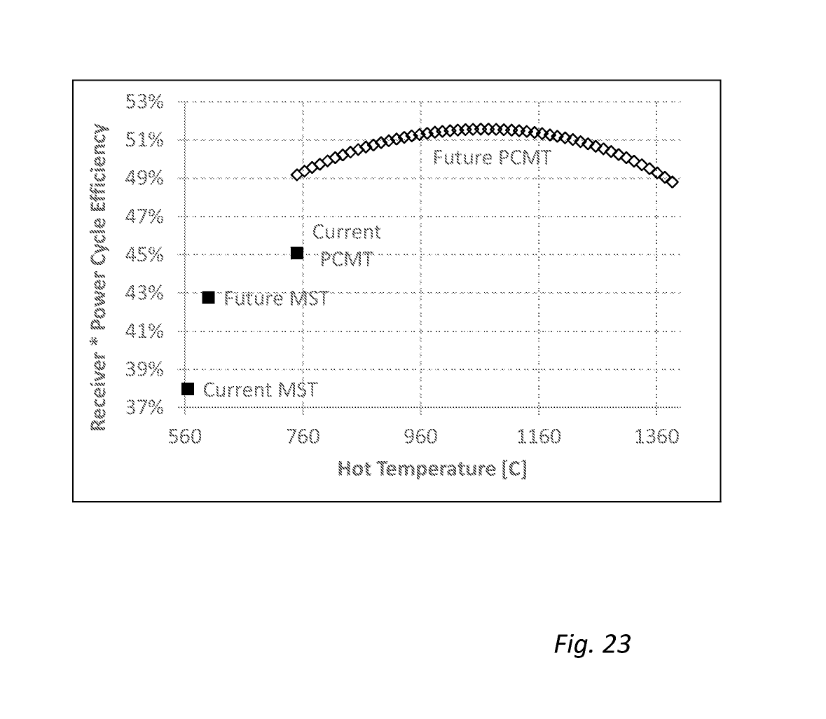

The various embodiments disclosed above all feature the use of a solid-liquid phase change material as a combination HTM and TES material. As noted above, certain metal alloys are particularly well-suited for use as an HTM with the disclosed systems. The melting and freezing point of a metal alloy can be selected such that the hot temperature of the HTM is near or above 1000° C. For example, as shown in FIG. 23, a metal alloy phase change material HTM can be selected which has a hot temperature of 760° C., 860° C., 960° C., 1060° C., 1160° C., 1260° C. or 1360° C. The selection or fabrication of a HTM providing an operational hot temperature above 760° C. allows for the use of more efficient power generation cycles. Thus, as graphically represented in FIG. 23, the projected overall power cycle efficiency achievable with a CSP is significantly enhanced.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

1. A concentrating solar power system comprising:
a solid-liquid phase change heat transfer material;
a solar receiver configured to receive concentrated solar flux to heat a quantity of the solid heat transfer material and cause at least a portion of the solid heat transfer material to melt to a liquid heat transfer material;
a heat exchanger in fluid communication with the solar receiver, the heat exchanger receiving liquid heat transfer material, and providing for heat exchange between the liquid heat transfer material and a working fluid of a power cycle, the heat exchanger further providing for the solidification of the liquid heat transfer material;
a material transport system providing for transportation of solid heat transfer material from the heat exchanger to the solar receiver; and
a hot storage tank in fluid communication with the solar receiver and the heat exchanger, the hot storage tank providing for thermal energy storage using the liquid heat transfer material as a thermal energy storage medium.

2. The system of claim 1 further comprising a cold storage tank in mechanical or fluid communication with the solidification stage and the solar receiver, the cold storage tank providing for storage of solid heat transfer material.

3. The system of claim 1 wherein the heat exchanger comprises a direct contact heat exchanger providing for physical contact between the heat transfer material and the working fluid.

4. The system of claim 3 wherein the heat exchanger comprises a priller.

5. The system of claim 4 wherein the solid heat transfer material input to the solar receiver comprises a slurry of the prill and liquid heat transfer material.

6. The system of claim 1 wherein the heat exchanger comprises a multiple stage heat exchanger comprising at least a primary stage where heat exchange occurs between liquid heat transfer material and the working fluid and a solidification stage where heat exchange between the heat transfer material and the working fluid causes solidification of the heat transfer material.

7. The system of claim 6 wherein the solidification stage comprises a billet fabricating apparatus.

8. The system of claim 7 wherein the solid heat transfer material input to the solar receiver comprises solid billets.

9. The system of claim 1 wherein the heat transfer material comprises an aluminum alloy.

10. The system of claim 9 wherein the working fluid comprises s-CO2.

11. (canceled)

12. The system of claim 1 wherein the solar receiver further comprises:
one or more receiver tubes containing a flow of substantially solid-phase heat transfer material;
one or more receiver tubes containing a flow of mixed solid and liquid phase heat transfer material; and
one or more receiver tubes containing a flow of substantially liquid-phase heat transfer material.

13. The system of claim 12 further comprising:
a tower supporting the solar receiver;
a solid receiver hopper located within the tower and configured to provide for the loading of solid heat transfer material into the receiver; and
a liquid receiver hopper located within the tower and configured to provide for the loading of liquid heat transfer material into the receiver.

14. The system of claim 1 wherein the solar receiver further comprises:
multiple receiver tubes oriented substantially vertically, the multiple receiver tubes having an opening associated with the material transport system providing for solid heat transfer material to be loaded into one or more of the multiple receiver tubes; and
an exit from the receiver tubes providing for the flow of liquid heat transfer material from the receiver.

15. The system of claim 14 wherein the multiple receiver tubes are arranged in a substantially circular array

16-28. (canceled)

29. A power generation method comprising:
providing a solid-liquid phase change heat transfer material;
placing solid heat transfer material into a solar receiver configured to receive concentrated solar flux;
heating at least a portion of the solid heat transfer material in the solar receiver to cause the solid heat transfer material to melt to a liquid phase;
storing at least a portion of the liquid heat transfer material in a hot thermal energy storage tank;
exchanging heat between the liquid heat transfer material and a working fluid of a power generation block to heat the working fluid to an operational temperature and to cause solidification of the liquid heat transfer material;
driving a power generation cycle with the energy of the heated working fluid; and
transporting solid heat transfer material to the solar receiver.

30. The method of claim 29 further comprising storing solid heat transfer material in a cold storage tank in mechanical or fluid communication with the solar receiver.

31. The method of claim 29 wherein the solidification step comprises prilling the liquid heat transfer material in a direct contact heat exchanger.

32. The method of claim 29 wherein the solid heat transfer material input to the solar receiver comprises a slurry of solid heat transfer material and liquid heat transfer material.

33. The method of claim 29 further comprising fabricating billets of solid heat transfer material from liquid heat transfer material.

34. The method of claim 29 further comprising transporting solid heat transfer material to the solar receiver with a mechanical conveyor.
